(19) United States
(12) Patent Application Publication
(10) Pub. No.: US 2015/0106335 A1
(43) Pub. Date: Apr. 16, 2015

(54) HIERARCHICAL DATA ARCHIVING

(71) Applicant: Exablox Corporation, Sunnyvale, CA (US)

(72) Inventors: Tad Hunt, Sunnyvale, CA (US); Frank E. Barrus, New Ipswich, NH (US)

(21) Appl. No.: 14/512,299

(22) Filed: Oct. 10, 2014

Related U.S. Application Data
(60) Provisional application No. 61/889,866, filed on Oct. 11, 2013.

(51) Int. Cl. G06F 17/30

(52) U.S. Cl. CPC G06F 17/30088; G06F 17/30073
USPC 707/639

(57) ABSTRACT

Disclosed is a file versioning system and corresponding methods for its operation. The file versioning system allows making snapshots of the file system every time there is a modification to the file system or its items. The snapshots may be linked to their immediate predecessors. Some older snapshots may be discarded according to a “thinning out” process based on multiple criteria. The snapshots may be displayed to a user in a manner making it easy to select a desired version.

### CROSS-REFERENCE TO RELATED APPLICATIONS

The present application claims benefit of U.S. provisional application No. 61/889,866 filed on Oct. 11, 2013. The disclosure of the aforementioned application is incorporated herein by reference for all purposes.

### TECHNICAL FIELD

This disclosure relates generally to data processing and, more particularly, to hierarchical data archiving.

### DESCRIPTION OF RELATED ART

The approaches described in this section could be pursued but are not necessarily approaches that have previously been conceived or pursued. Therefore, unless otherwise indicated, it should not be assumed that any of the approaches described in this section qualify as prior art merely by virtue of their inclusion in this section.

A traditional file system typically maintains only the latest version of its files. If a user wishes to maintain multiple versions of the same file, the user may store them manually. The clean-up of the unneeded intermediary versions is also performed manually. Maintaining multiple versions of a file in a traditional file system can be resource-expensive.

Various software solutions have been developed to maintain multiple file versions of file systems based on predetermined time criteria so that the entire file system is backed up at predetermined times. This approach may be computationally expensive.

There are also versioning solutions which allow storing files once they are modified, rather than on the time basis. Such versioning solutions provide for existence of several versions of the same file at the same time. However, traditional versioning solutions archive previous versions of files on a separate resource which is not part of the global namespace associated with the current version. Thus, if a user needs to access an older version of a file, a file system administrator may use his tools and credentials to manually search through archives located on a separate resource, which makes the use of such versioning solutions cumbersome.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

According to an aspect of the present disclosure, a method is provided for maintaining a file versioning system. The method may comprise determining, by one or more processors, that a modification to a file system has been made. Based on the determination, the method may perform, by the one or more processors, a snapshot of the file system. Further, the method may include virtually linking, by the one or more processors, the snapshot to at least one of a plurality of predecessor snapshots. The method may also include dynamically discarding, by the one or more processors, one or more snapshots of the plurality of predecessor snapshots based on one or more predetermined criteria.

In certain embodiments, the modification of the file system may include a modification to an existing file, creation of a new file, deletion of an existing file, and, similarly, a modification of an existing folder, creation of a new folder, deletion of an existing folder, or any other modifications to a file system. In various embodiments, the snapshot of the file system taken based on a modification may include the state of the file system at a particular point of time associated with the modification. Each snapshot may include the modified file or folder (or newly created file or folder) as well as information concerning the file system as a whole. When there is a need for a user to save multiple versions of a particular file or folder, the present disclosure provides for automated storing of such file or folder versions so that they can be searched by the user in an easy and efficient manner.

In certain embodiments, every time a new snapshot of the file system is taken, the newly taken snapshot may be virtually linked to the immediate predecessor snapshot. The virtual linking may include a reference, a link, a file path, or any other information suitable for cross-referencing snapshots. In certain embodiments, the snapshots are linked in a time-ordered manner. In certain embodiments, all snapshots are stored and none are deleted. Furthermore, in certain embodiments, the snapshots, and the file versioning system in general, are associated with the file namespace presented to a user.

In certain embodiments, the present technology may use garbage collection or “thinning out” processes to dynamically discard intermediate snapshots that are deemed to be of lesser value based on a predetermined thinning out criteria. Assessment of snapshot value may be based upon timing information. In certain embodiments, the snapshots can be thinned out based on time, such that all recent snapshots (e.g., taken within the last hour) are kept and only a predetermined number of older snapshots, depending on the time period (e.g., taken more than 24 hours ago but less than 48 hours ago), is kept. Accordingly, snapshots can be thinned out as they become older. If a snapshot is no longer maintained (thinned out) by the system, the snapshot following the thinned out snapshot can be re-linked to the snapshot immediately preceding the thinned out snapshot.

In further example embodiments of the present disclosure, there is provided a file versioning system configured to implement the method steps. In yet other example embodiments of the present disclosure, the method steps are stored on a machine-readable medium comprising instructions, which when implemented by one or more processors perform the recited steps. In yet further example embodiments, hardware systems or devices can be adapted to perform the recited steps. Other features, examples, and embodiments are described below.

### BRIEF DESCRIPTION OF THE DRAWINGS

Embodiments are illustrated by way of example, and not by limitation, in the figures of the accompanying drawings, in which like references indicate similar elements.

FIGS. 1A-1F illustrate high level diagrams of a file system and its modification over time.

FIG. 2 shows an example embodiment of the file system with a dedicated snapshot directory for storing snapshots and file versions.

FIG. 3 shows an example timeline with timestamps of snapshots maintained in a snapshot directory.

FIG. 4 shows a high level block diagram of network architecture suitable for implementing embodiments of the present disclosure.

FIG. 5 is a process flow diagram showing a method for maintaining a file versioning system, according to an example embodiment.

FIG. 6 shows a diagrammatic representation of a computing device for a machine in the example electronic form of a computer system, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is therefore not to be taken in a limiting sense, and the scope is defined by the appended claims and their equivalents. In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

The techniques of the embodiments disclosed herein may be implemented using a variety of technologies. For example, the methods described herein may be implemented in software executing on a computer system or in hardware utilizing either a combination of microprocessors or other specially designed application-specific integrated circuits (ASICs), programmable logic devices, or various combinations thereof. In particular, the methods described herein may be implemented by a series of computer-executable instructions residing on a storage medium such as a disk drive, or computer-readable medium. It should be noted that methods disclosed herein can be implemented by a computer (e.g., a desktop computer, tablet computer, laptop computer, and server), game console, handheld gaming device, cellular phone, smart phone, smart television system, storage appliance, and so forth.

The technology described herein relates to a file versioning system and corresponding methods for its operation. According to various embodiments of the present disclosure, the file versioning system provides for making snapshots of a file system every time there is a modification to the file system (or file directory) or its items (files, folders). The snapshots may include information regarding the state of a file system at a particular point of time, information regarding specific modifications, and, optionally, links to one or more other snapshots (when applicable). In certain embodiments, the snapshots may include modified file system items in addition to the general information concerning the file system state. According to various embodiments, the snapshots may be displayed to a user in such a way that it is easy to select a version in which he is interested. In this regard, the snapshots may be displayed and sorted in a chronological manner, which may be possible, for example, when the snapshots are associated with filenames having date and time information (timestamps).

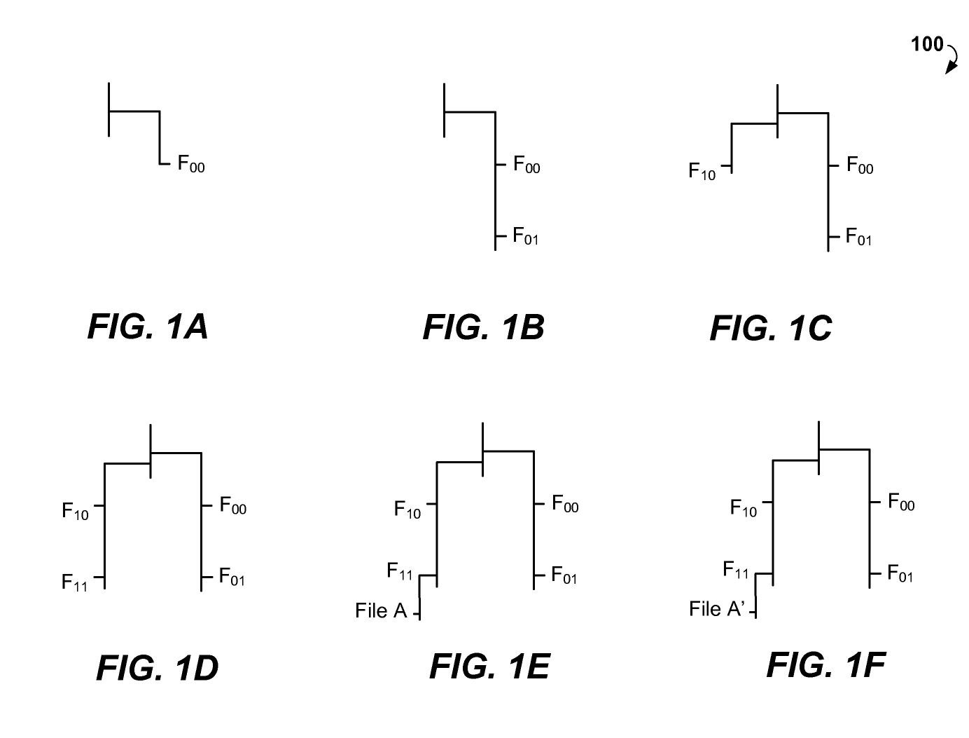

FIGS. 1A-1F illustrate high level diagrams of a file system 100 and its modification over time. In particular, FIG. 1A shows the file system 100 at a first time instance, wherein the file system 100 includes a root with a single file folder F₀₀. FIG. 1B shows the file system 100 modified by adding another folder F₀₁ to the folder F₀₀. Furthermore, FIG. 1C shows the file system 100 modified by adding another folder F₁₀ to the root. FIG. 1D shows the file system 100 modified by adding another folder F₁₁ to the folder F₁₀. FIG. 1E illustrates the file system 100 modified by storing file A to the folder F₁₁. FIG. 1F shows the file system 100 modified by modifying the file A (denoted in the figure as file A′). According to various embodiments, a snapshot is generated for every modification of the file system 100 as shown in FIG. 1A-1F. These snapshots may be virtually linked to each other. For example, the file A′ (FIG. 1F) may be linked to the file A (FIG. 1E), while the file system shown in FIG. 1E may be linked to the file system shown in FIG. 1D, and so forth. In other words, the snapshots may be linked to their immediate predecessors.

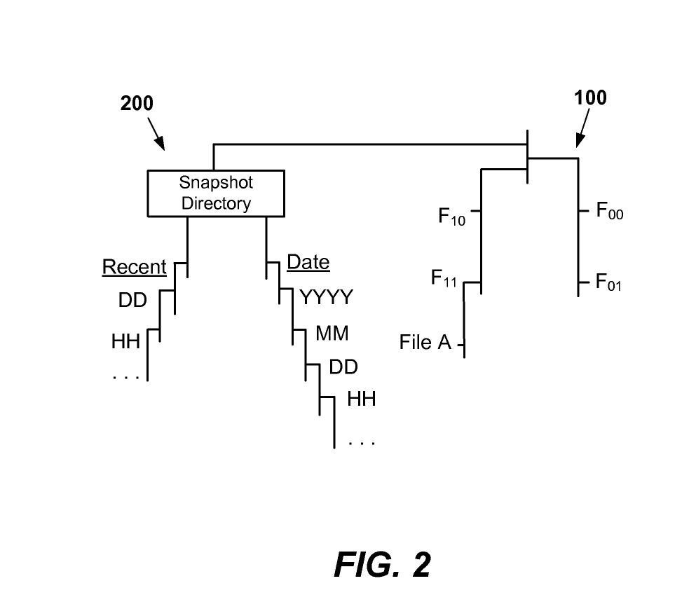

According to embodiments of the present disclosure, the snapshots may be stored in a virtual directory added to the root of the file system 100. FIG. 2 shows an example embodiment of the file system 100 with a dedicated snapshot directory 200 for storing snapshots and file versions. In certain embodiments, the directory 200 is virtual and may have no corresponding structure on a hard disk; instead the directory 200 may refer to a runtime software construct. However, underlying mechanics of constructing the directory are transparent to end users as the directory looks “real” allowing the user to explore the snapshots stored therein.

The directory 200 may include a plurality of folders, and the snapshots may be sorted in the folders of the directory 200 following predetermined criteria as discussed below. For example, the directory 200 may include two main folders, one called “Recent” and the other one called “Date.” The Recent folder may store snapshots taken within a predetermined time period from the current time. For example, the Recent folder may store a maximum of one snapshot per second within the last hour of operation. The Recent folder may have a limit to the number of snapshots stored therein. The Date folder may maintain all snapshots, including those taken during the last hour and stored in the Recent folder.

Furthermore, the snapshots stored in these folders may be split into trees by date and/or time. In an example embodiment, which is shown in FIG. 2, the trees may include folders corresponding to years, months, dates, hours, minutes, seconds, milliseconds, microseconds, nanoseconds, and so forth. Thus, there may be 12 folders for months, 365 folders for day level for each year, 8760 folders created at the hour level, and so on. Moreover, the snapshots' names may include the date and/or time when they were taken. For example, the snapshot name may be formed as the following: “yyyy-mm1-dd_hh-mm2-ss,” where “yyyy” stands for a four digit year number, “mm1” stands for a two digit month number, “dd” stands for a two digit day number, “hh” stands for a two digit hour number, “mm2” stands for a two digit minute number, and “ss” stands for a two digit second number. Accordingly, the snapshots may be selectively stored in corresponding folders. It should be clear to those skilled in the art that the hierarchical tree structure described herein allows for easy search and navigation among multiple snapshots, thereby making it convenient for users to find a desired file version. As was mentioned above, the snapshot directory 200 refers to a run-time virtual construct which may be dynamically created once accessed by the end user for the purposes of presentation.

According to various embodiments, the snapshot directory 200 may include two utility files such as “snapshots.txt” and “rsnapshots.txt.” These files may also be virtual and are used for listing of all snapshots stored therein. In certain embodiments, these files are text files, which make it easy to parse information in large directories, although other formats are also possible.

An example structure of the “snapshots.txt” and “rsnapshots.txt” files is provided in the following Table 1:

TABLE 1

| Date | Snapshot ID | Root Hash | Operation |
|---|---|---|---|
| . . . | . . . | . . . | . . . |

As shown in this table, these files may include a database having columns for a date, a snapshot Identification (ID), root hash, and operation. Every modification to the file system 100 may be reflected in corresponding strings stored in these files. The “Date” field may include both date and time. The “Snapshot ID” may include a unique identification number of the modification. The “Root Hash” may be associated with a version of the file system 100, and may be generated by any suitable hash algorithm such as one of SHA cryptographic algorithms. The “Operation” column may include modification information that caused the snapshot to be taken, and may refer, for example, to a write operation, set rights operation, splicing operation, and so forth.

The snapshot identifier may be generated at substantially the same time as the file modification occurs. In an example embodiment, the process for making snapshots may commence with receiving a modification request from a client. The last snapshot identifier may be fetched from the last root inode. A new snapshot identifier may be computed by incrementing the last snapshot identifier. Furthermore, the modification may be performed and the new snapshot identifier may be included in the inodes affected by the change. If the modification results in new versions of existing inodes, the new versions may be linked to the old versions and the old versions may be linked to the new versions (i.e., a bi-directionally linked list may be created). A new root inode may be created by duplicating the starting root inode, inserting the new snapshot identifier into the new root inode, and bi-directionally linking the new root inode and the previous root inode. The modification process may conclude with informing the client that the modification operation is completed.

In certain embodiments, every time a new snapshot is taken, a new construct is generated with its root pointing to its immediate predecessor version. Its root can be identified by an identifier (e.g., a hash value resulting from a SHA algorithm run over the content of the file version). Thus, the “snapshot.txt” file can be generated by traversing roots of the snapshots identified by corresponding identifiers/hashes.

The snapshots stored in “snapshots.txt” may be sorted in an ascending manner, but may be sorted in descending manner in the “rsnapshots.txt” file. The reason for having two different files listing snapshots in reverse order is to provide for higher performance of different analyses without having to sort the list first. For example, if a user is only interested in the latest version, “snapshots.txt” will allow accessing the latest version at the top of the list.

In various embodiments of the present disclosure, the snapshot directory 200 is intended to keep all versions of the file system 100. To this end, Continuous Data Protection (CDP) principles may be applied so that all modifications to file system items are tracked and stored.

In various embodiments of the present disclosure, some snapshots may be discarded by a process referred to as “thinning out.” Thinning out of a snapshot is not equivalent to deletion of a file as only one version of the file is deleted.

According to the “thinning out” process, if a specific version of the file system 100 (i.e., a snapshot) is discarded, the subsequent version of the file system 100 is re-linked to its immediate predecessor. For example, if there are snapshots 1, 2, 3, 4, 5, and 6, where the snapshot 6 follows snapshot 5, while the snapshot 5 follows the snapshot 4, and so on, after discarding the snapshot 5, the snapshot 6 is made to follow the snapshot 4.

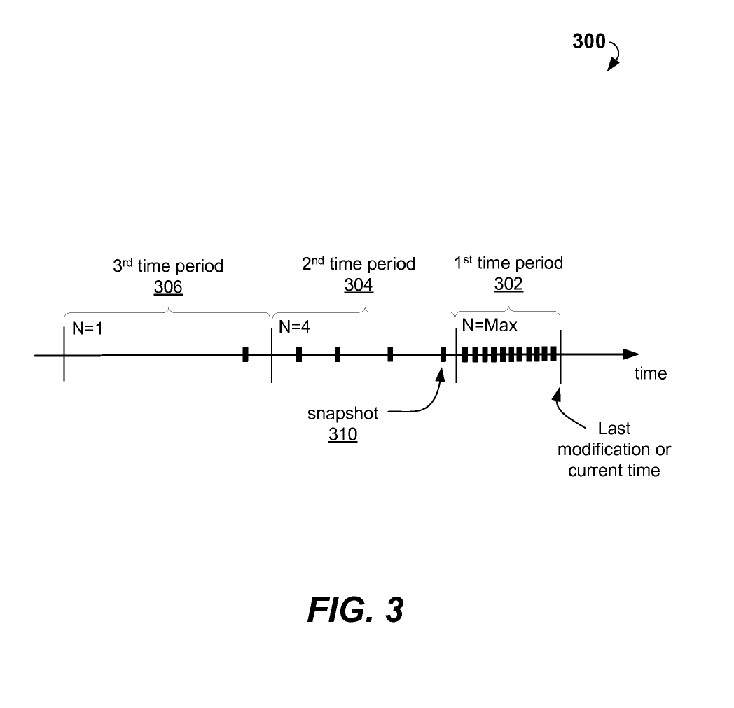

Further, in accord with various embodiments of the present disclosure, the snapshots of the file system 100 may be discarded based upon timing information. In particular, the snapshots may be chronologically categorized according to various time periods in the past. FIG. 3 shows an example timeline 300 showing how snapshots are maintained in the snapshot directory 200. As shown in the figure, the timeline 300 is split in three time periods. The first time period 302, which immediately precedes the last modifying operation (e.g., writing a file), may refer to a 5 minute time period from the current time. The second time period 304 may constitute a period from 5 minutes ago to 60 minutes ago, and the third time period 306 may include the remaining time.

In certain examples, each time period may maintain a limited number N of snapshots. For example, with respect to the first time period 302, all taken snapshots (e.g., one for every modification) may be stored. Furthermore, for the second time period 304, a predetermined limited number of snapshots (e.g., N=4) may be maintained, whereas the snapshots pertaining to the second time period 304 may be evenly distributed over the timeline, and may include the earliest snapshots (i.e., the closest to the right boundary of this time period). Lastly, for the third time period 306, another predetermined limited number of snapshots (e.g., N=1) may be maintained. Those skilled in the art will appreciate that the above is just an example embodiment and any other suitable rules or criteria may be applied to how snapshots are maintained and how intermediate snapshots are discarded.

In general, various criteria can be used for deciding which snapshots should be kept and which snapshots should be discarded. In certain embodiments, it may depend on the time elapsed since the last operation, although other criteria may be utilized such as criteria based upon specific operations or number of operations. It should also be clear that the number of time periods discussed above may be more than three or less than three.

In an example embodiment, the newest snapshot should always be kept. Therefore, for the periods that keep only one snapshot, the latest should be kept, but in periods where more than one snapshot is kept, it should be the newest and the other snapshots should be evenly distributed through its time period. If there are fewer snapshots than the predetermined number of snapshots to be kept in a specific time period, all snapshots are kept. Where all snapshots are bunched together, the distribution should change accordingly.

In various embodiments, the discarding of snapshots may not always depend on time information; instead, the content of the file modified may be analyzed to make decisions as to whether a particular snapshot is to be kept or not. For example, content sniffing can be utilized to look into the files themselves and make decisions based on the content. If there is not enough data yet to make a decision, it may be useful to keep snapshots generated after a synch between the stored data and remote data of the application that wrote the data.

To sum up the above, the “thinning out” process may follow one or more predetermined policies to decide which snapshots are to be kept in the snapshot directory 200. The policy may be based on time elapsed since the last file system modification, modification type, changes to file system, operation types, content, durations, granularities, and so forth.

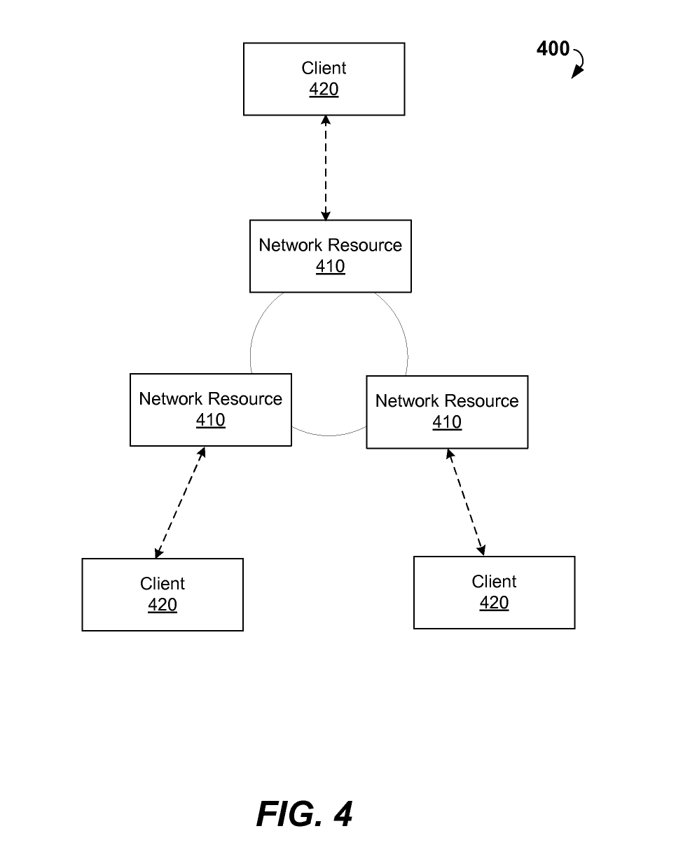

FIG. 4 shows a high level block diagram of network architecture 400 suitable for implementing embodiments of the present disclosure. In particular, the network architecture 400 may be deployed to manage all or a portion of a global namespace and include, for example, a ring of networked resources 410 (e.g., storage appliances that provide access to data objects), which may be accessed by clients 420. In the example shown, there are three clients 420, each of which may browse a file system associated with the ring. Moreover, each client 420 may see snapshots associated with changes made by other clients 420, which make it possible for a group of end users to utilize the same file system and take advantage of utilizing a global file versioning system allowing access to file versions created by any of the users of the architecture 400.

The architecture 400 may include a versioning module (not shown) configured to implement the technology described herein. The versioning module may include virtual components (e.g., software code) and/or hardware components (e.g., logic, processors, memory).

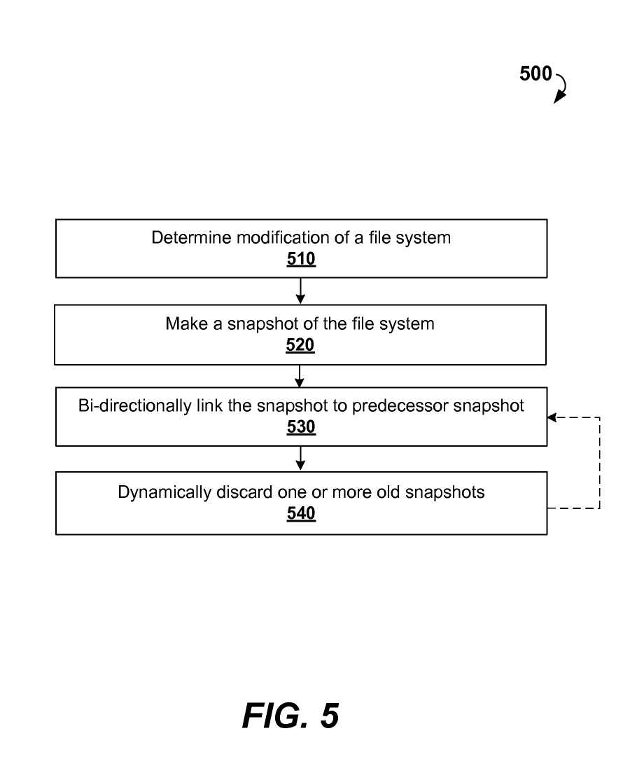

FIG. 5 is a process flow diagram showing a method 500 for maintaining a file versioning system, according to an example embodiment. The method 500 may be performed by processing logic that may comprise hardware (e.g., decision making logic, dedicated logic, programmable logic, and microcode), software (such as software run on a general-purpose computer system or a dedicated machine), or a combination of both.

As shown in FIG. 5, the method 500 may commence at operation 510 with the versioning module monitoring the file system 100 and determining a modification of the file system. The modification may include a write operation, modifying a file, creating or deleting file or folder, changing properties of file or folder, and so forth.

At operation 520, the versioning module makes a snapshot of the file system once any modifications are determined at the operation 510. The plurality of snapshots (e.g., at least two) are linked together at operation 530. For example, a newly taken snapshot and its immediate predecessor may be bi-directionally linked together.

At operation 540, the versioning module implements the “thinning out” process by dynamically discarding one or more previously taken snapshots based on one or more predetermined criteria such as timing information associated with the time of the last modification of the file system 100. The operation 540 may run asynchronously with respect to other operations of the method 500. After the “thinning out” process, the snapshot following the thinned out snapshot may be bi-directionally re-linked to the snapshot immediately preceding the thinned out snapshot.

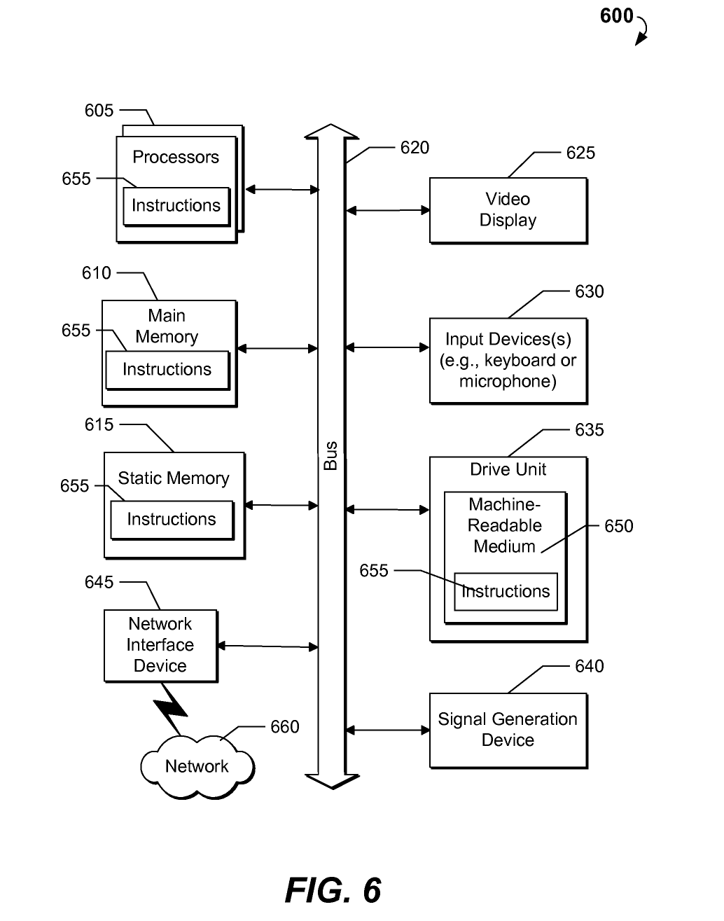

FIG. 6 shows a diagrammatic representation of a computing device for a machine in the example electronic form of a computer system 600, within which a set of instructions for causing the machine to perform any one or more of the methodologies discussed herein can be executed. In various example embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a personal digital assistant (PDA), a cellular telephone, a portable music player (e.g., a portable hard drive audio device, such as an Moving Picture Experts Group Audio Layer 3 (MP3) player), gaming pad, portable gaming console, in-vehicle computer, smart-home computer, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor or multiple processors 605 (e.g., a central processing unit (CPU), a graphics processing unit (GPU), or both), and a main memory 610 and a static memory 615, which communicate with each other via a bus 620. The computer system 600 can further include a video display unit 625 (e.g., a liquid crystal display). The computer system 600 may also include at least one input device 630, such as an alphanumeric input device (e.g., a keyboard), a cursor control device (e.g., a mouse), a microphone, a digital camera, a video camera, and so forth. The computer system 600 may also include a disk drive unit 635, a signal generation device 640 (e.g., a speaker), and a network interface device 645.

The disk drive unit 635 includes a computer-readable medium 650, which stores one or more sets of instructions and data structures (e.g., instructions 655) embodying or utilized by any one or more of the methodologies or functions described herein. The instructions 655 can also reside, completely or at least partially, within the main memory 610 and/or within the processors 605 during execution thereof by the computer system 600. The main memory 610 and the processors 605 also constitute machine-readable media.

The instructions 655 can further be transmitted or received over a network 660 via the network interface device 645 utilizing any one of a number of well-known transfer protocols (e.g., Hyper Text Transfer Protocol (HTTP), CAN, Serial, and Modbus). For example, the network 660 may include one or more of the following: the Internet, local intranet, PAN (Personal Area Network), LAN (Local Area Network), WAN (Wide Area Network), MAN (Metropolitan Area Network), virtual private network (VPN), storage area network (SAN), frame relay connection, Advanced Intelligent Network (AIN) connection, synchronous optical network (SONET) connection, digital T1, T3, E1 or E3 line, Digital Data Service (DDS) connection, DSL (Digital Subscriber Line) connection, Ethernet connection, ISDN (Integrated Services Digital Network) line, cable modem, ATM (Asynchronous Transfer Mode) connection, or an FDDI (Fiber Distributed Data Interface) or CDDI (Copper Distributed Data Interface) connection. Furthermore, communications may also include links to any of a variety of wireless networks including, GPRS (General Packet Radio Service), GSM (Global System for Mobile Communication), CDMA (Code Division Multiple Access) or TDMA (Time Division Multiple Access), cellular phone networks, Global Positioning System (GPS), CDPD (cellular digital packet data), RIM (Research in Motion, Limited) duplex paging network, Bluetooth radio, or an IEEE 802.11-based radio frequency network.

While the computer-readable medium 650 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, flash memory cards, digital video disks (DVDs), random access memory (RAM), read only memory (ROM), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, Python, Go, C++, Perl, UNIX Shell, Visual Basic or Visual Basic Script, Virtual Reality Markup Language (VRML), ColdFusion™ or other compilers, assemblers, interpreters or other computer languages or platforms.

Thus, methods for hierarchical data achieving have been disclosed. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

1. A method for maintaining a file versioning system, the method comprising:
determining, by one or more processors, a modification of the file system;
based on the determination, making, by the one or more processors, a snapshot of the file system;
linking, by the one or more processors, the snapshot to at least one of a plurality of predecessor snapshots; and
dynamically discarding, by the one or more processors, one or more snapshots of the plurality of predecessor snapshots based on one or more predetermined criteria.

2. The method of claim 1, wherein the modification of the file system includes one of the following: creating a new file, modification of a content of an existing file, deleting an existing file, changing one or more properties of an existing file, creating a new folder, modification of a content of an existing folder, deletion of an existing folder, and changing one or more properties of an existing folder.

3. The method of claim 1, wherein the snapshot includes one or more of the following: a modified file, a created file, a modified folder, and a created folder.

4. The method of claim 1, wherein the snapshot includes an identifier of the snapshot, date and time associated with the modification, information regarding the modification, information regarding a state of the file system at a point of time associated the modification, and at least one link to at least one of predecessor snapshot from the plurality of predecessor snapshots.

5. The method of claim 1, further comprising, storing in a database, information describing the snapshot, the plurality of predecessor snapshots, and a link between the snapshot and at least one of the plurality of predecessor snapshots.

6. The method of claim 5, further comprising accessing the snapshot through a virtual folder added to a root of the file system, wherein the virtual folder provides access to the plurality of predecessor snapshots.

7. The method of claim 6, wherein the plurality of predecessor snapshots in the virtual folder is split into trees of subfolders labeled by date or by date and time, where the date and the time are date and time of making the snapshot.

8. The method of claim 1, further comprising, while dynamically discarding the one or more snapshots, linking a successor of a deleted snapshot to an immediate predecessor of the deleted snapshot.

9. The method of claim 1, wherein the one or more predetermined criteria is based on points of time of making the one or more snapshots.

10. The method of claim 1 further comprising:
dividing time passed from a pre-determined point of time to a point of time of a last modification in file system into two or more time periods; and
assigning each particular time period from the two or more time periods a number of snapshots made in the particular time period to be kept in the file system.

11. The method of claim 10, wherein a time period from the two and more time periods located closer to the point of time of the last modification contains more snapshots kept in the file system.

12. The method of claim 1, wherein the one or more predetermined criteria is based on content associated with one or more snapshots.

13. The method of claim 1, wherein the one or more predetermined criteria is based on a type of a modification associated with one or more snapshots.

14. A system for maintaining a file versioning system, the system comprising:
one or more processors; and
a memory communicatively coupled with the one or more processors, the memory storing instructions which when executed by the one or more processors performs a method comprising:
determining, by one or more processors, a modification of the file system;
based on the determination, making, by the one or more processors, a snapshot of the file system;
linking, by the one or more processors, the snapshot to at least one of a plurality of predecessor snapshots; and
dynamically discarding, by the one or more processors, one or more snapshots of the plurality of predecessor snapshots based on one or more predetermined criteria.

15. The system of claim 14, wherein the modification of file system includes one of the following: creating a new file, modification a content of an existing file, deleting an existing file, changing one or more properties of an existing file, creating a new folder, modification a content of an existing folder, deletion of an existing folder, and changing one or more properties of an existing folder.

16. The system of claim 14, wherein the snapshot includes one or more of the following: a modified file, a created file, a modified folder, and a created folder.

17. The system of claim 14, wherein the snapshot includes an identifier of the snapshot, date and time associated with the modification, information regarding the modification, information regarding a state of the file system at a point of time associated the modification, and at least one link to at least one of predecessor snapshot from the plurality of predecessor snapshots.

18. The system of claim 14, further comprising storing, in a database, information describing the snapshot, the plurality of predecessor snapshots, and a link between the snapshot and at least one of the plurality of predecessor snapshots.

19. The system of claim 18, further comprising accessing the snapshot through a virtual folder added to a root of the file system, wherein the virtual folder provides access to the plurality of predecessor snapshots.

20. The system of claim 19, wherein the plurality of predecessor snapshots in the virtual folder is split into trees of subfolders labeled by date or by date and time, where the date and the time is date and time of making the snapshot.

21. The system of claim 14 further comprising, while dynamically discarding one or more snapshots:
linking a successor of a deleted snapshot to an immediate predecessor of the deleted snapshot.

22. The system of claim 14, wherein the one or more predetermined criteria is based on points of time of making the one or more snapshots.

23. The system of claim 14 further comprising:
dividing a time passed from a pre-determined point of time to a point of time of a last modification of the file system into two and more time periods; and
assigning each particular time period from the two and more time periods a number of snapshots made in the particular time period to be kept in the file system.

24. The system of claim 23, wherein a time period from the two and more time periods located closer to the point of time of the last modification contains more snapshots kept in the file system.

25. The system of claim 14, wherein the one or more predetermined criteria is based on content associated with one or more snapshots.

26. The method of claim 14, wherein the one or more predetermined criteria is based on a type of a modification associated with one or more snapshots.

27. A non-transitory processor-readable medium having instructions stored thereon, which when executed by one or more processors, cause the one or more processors to perform the following steps of a method for maintaining a file versioning system, the method comprising:
determining, by one or more processors, a modification of the file system;
based on the determination, making, by the one or more processors, a snapshot of the file system;
linking, by the one or more processors, the snapshot to at least one of a plurality of predecessor snapshots; and
dynamically discarding, by the one or more processors, one or more snapshots of the plurality of predecessor snapshots based on one or more predetermined criteria.
